(19) United States
(12) Patent Application Publication
(10) Pub. No.: US 2014/0318877 A1
(43) Pub. Date: Oct. 30, 2014

(54) Wind Powered Vehicle System

(71) Applicant: Beverly Custis Diggs Edwards, JR., Oden, AR (US)

(72) Inventor: Beverly Custis Diggs Edwards, JR., Oden, AR (US)

(21) Appl. No.: 13/874,091

(22) Filed: Apr. 30, 2013

(51) Int. Cl. B60K 3/02

(52) U.S. Cl. CPC B60K 3/02
USPC 180/54.1

(57) ABSTRACT

This is a wind powered compressed air vehicle having a chassis frame, compressed air piston driven motor, wheels and an insulated storage tank for compressed air and adapted to receive compressed air from an accumulator compressed air storage tank, which in turn is connected to a wind turbine driven air compressor.

### BACKGROUND OF THE INVENTION

The field of the invention relates to a vehicle system powered by wind generated compressed air. More particularly, the invention relates to a large wind driven turbine that drives an air compressor for producing compressed air and a compressed air powered vehicle engine which receives and uses the wind turbine generated compressed air. The vehicle could be such as an automobile, truck or tractor. The invention known as the Wind Powered Vehicle System is unique in that it runs on compressed air generated by a wind turbine powered air compressor. Conventional vehicles use petroleum fuels such as gasoline or diesel, which when burned to drive the engine, emit air pollution or greenhouse gases such as carbon monoxide. This air pollution is harmful to the health of living creatures and may cause global warming. Petroleum or fossil fuels are not renewable resources. The purpose of the Wind Powered Vehicle System is to run on a totally renewable resource fuel which is air, and it emits no air pollution in any part of the system. Conventional existing petroleum fueled vehicles can be modified to run on compressed air with the Wind Powered Vehicle System by removing their petroleum fueled engine and fuel tank and replacing it with the Wind Powered Vehicle System engine and drive train and compressed air fuel tank.

### BRIEF SUMMARY OF THE INVENTION

All of the components of the Wind Powered Vehicle System are currently available today as off of the shelf hardware, which is currently being manufactured. This is an application that combines existing proven hardware components into a unique system that powers a vehicle with non-polluting compressed air, that is generated by a wind turbine powered air compressor. The basic components are a large land based wind turbine that drives an air compressor, that pipes compressed air into a high pressure insulated storage tank, that can then pipe compressed air into a vehicle insulated compressed air fuel tank, that fuels a piston driven air motor, that drives the vehicle. All of the individual components of the system have been in service for a long time in other applications.

### BRIEF DESCRIPTION OF THE SEVERAL VIEWS OF THE DRAWINGS

FIG. 1 is a top perspective view of the whole assembled Wind Powered Vehicle System.

FIG. 2 is a front elevation view of the large wind turbine, with its horizontal wind turbine axle that direct drives the air compressor that furnishes high pressure compressed air to the system.

FIG. 3 is a side elevation view of the large wind turbine, with its horizontal wind turbine axle that direct drives the air compressor that furnishes high pressure compressed air to the system.

FIG. 4 is a plan view of the Wind Powered Vehicle, which is fueled with compressed air from the air compressor that is mounted on the wind turbine axle.

FIG. 5 is a side elevation view of the Wind Powered Vehicle, which is fueled with compressed air from the air compressor that is mounted on the wind turbine axle.

### DETAILED DESCRIPTION OF THE INVENTION

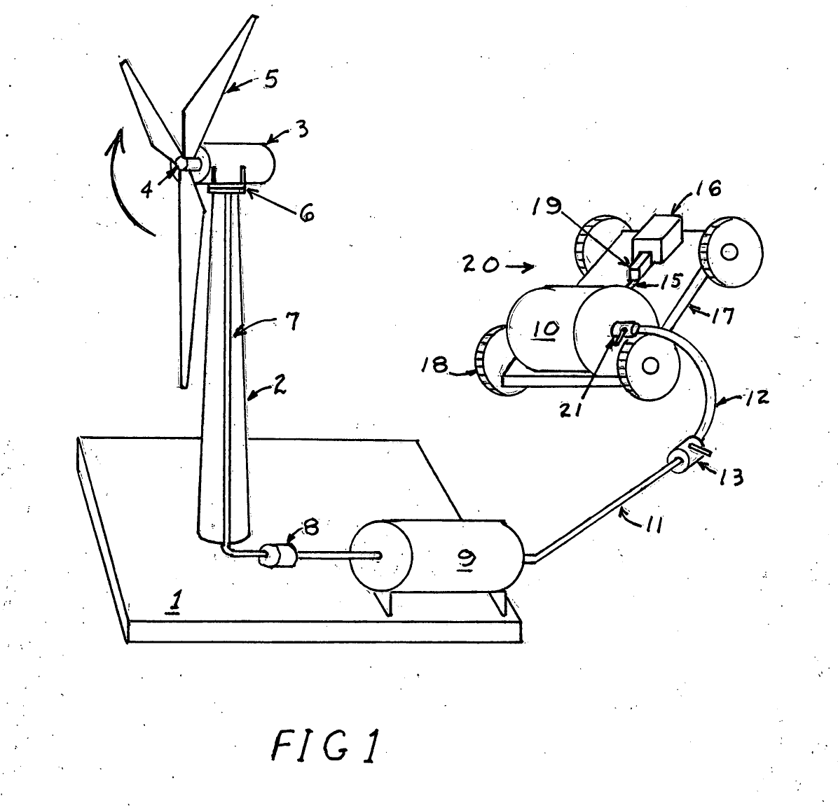

Referring now to the schematic diagram in FIG. 1, the overall invention is seen comprising a source of wind powered compressed air, a facility for accumulating and storing the compressed air and a vehicle utilizing the compressed air as a power source for locomotion. FIG. 1 illustrates the Wind Powered Vehicle System comprising a foundation base unit 1, having mounted thereon a turbine tower 2, with a wind turbine driven turret mounted rotating air compressor 3 mounted on the uppermost end of the tower 2. The wind turbine driven air compressor 3 is mounted on a swivel joint 6 that facilitates turning of the wind turbine and its air compressor into the wind so that the wind turbine blades 5 will rotate in response to the wind.

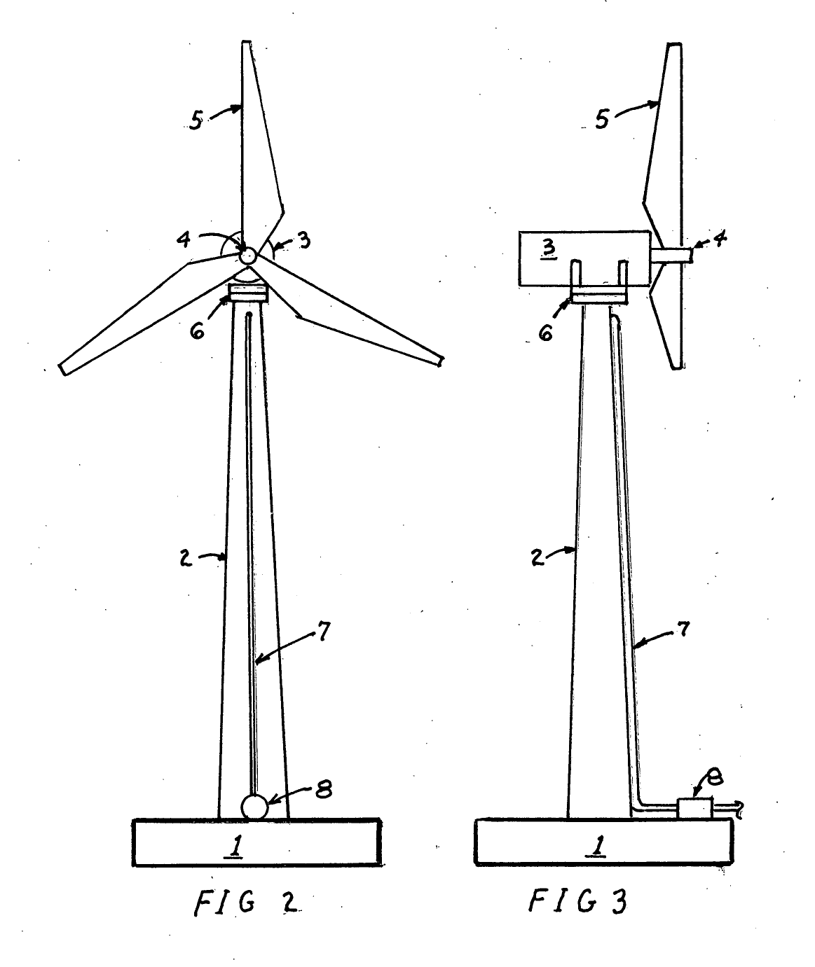

FIGS. 1, 2 and 3 show a very large fixed foundation base 1 that supports a wind turbine that is located and installed in a geographic area that has a relatively high average annual wind speed. This might be on top of a high hill, in an open field, on a sea coast, in a canyon or other location that has an unobstructed flow of strong wind currents. The wind turbine driven air compressor 3 is mounted on top of a tower 2 to avoid wind turbulence ground effects. Wind turbines or wind mills have been manufactured for a very long time in various configurations. This wind turbine is unique because it drives an air compressor 3 that is mounted in the central rotating hub body of the wind turbine. The rotating axle 4 of the wind turbine is driven by wind force which is applied to the air foil or drag type blades 5 which, as they pass through the air, cause the axle 4 to rotate. The rotating wind turbine axle 4 drives an air compressor 3 by a direct drive axle 4, or through a geared or hydraulic transmission. This is a very high pressure air compressor that compresses air to many times normal atmospheric pressure. Atmospheric air is drawn into the air compressor 3 where the air is compressed and delivered through a high pressure rotating swivel joint 6 atop tower 2 into a high pressure air supply pipeline 7. The air supply pipeline 7 runs down the tower 2 to ground level where it delivers compressed air through a one way check valve 8 and into a very large insulated high pressure accumulator air storage tank 9. The large reservoir of high pressure air stored in the tank 9 is a filling station for many vehicles that are powered by compressed air driven piston motors.

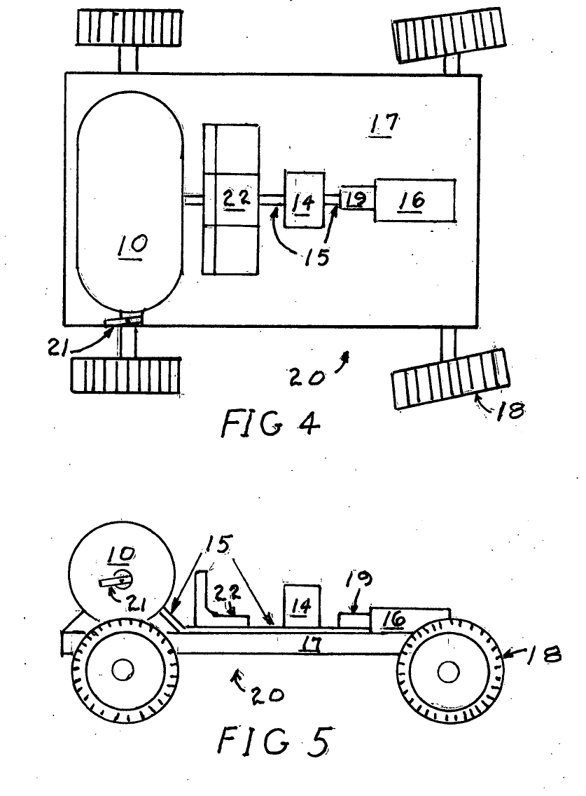

A unique vehicle 20 has a chassis frame 17 that contains a small insulated high pressure compressed air accumulator storage or fuel tank 10 mounted on the vehicle chassis frame 17, as shown in FIGS. 1, 4 and 5. This vehicle insulated air tank 10 is filled with compressed air by a pipeline 11 and a disconnectible flexible high pressure air hose 12 from the filling station large insulated compressed air tank 9. Supply pipeline valve 13 is opened allowing high pressure air to flow from the filling station tank 9 into the vehicle 20 insulated air fuel tank 10 through vehicle tank valve 21. The valves 13 and 21 are closed when the vehicle 20 fuel tank 10 is filled with compressed air. The vehicle 20 is fueled with high pressure compressed air. The vehicle 20 control panel 14 contains a vehicle steering wheel, a vehicle braking system and a compressed air pipeline throttle control valve. The compressed air in the vehicle fuel tank 10 is released through the compressed air pipeline throttle control valve in the vehicle control panel 14 by the driver seated in the driver and passenger seats 22. Compressed air flows from the air fuel tank 10 down an air supply pipeline 15 to a piston driven air motor 16 that drives the vehicle 20. The piston driven air motor 16 drives the vehicle wheels 18 through a geared or hydraulic transmission 19. The vehicle 20 is uniquely fueled by high pressure compressed air that drives a piston driven air motor 16. Conventional vehicles that burn gasoline or diesel fuel could be converted or retrofitted with a compressed air fuel tank 10, a compressed air fuel pipeline 15, a compressed air pipeline throttle control valve in the vehicle control panel 14, and a piston driven air motor 16. The compressed air powered vehicle disconnects the flexible fuel line 12 and drives out of the filling station. It drives around depleting its compressed air supply and then it returns to such a filling station for refueling.

All of the components described above are presently manufactured. The Wind Powered Vehicle System is a unique combination or system of existing components that produce an air pollution free vehicle.

1. The Wind Powered Vehicle System comprises:
A vehicle frame that has wheels, a steering system , a piston driven air motor, and a means for operably connecting the wheels, steering system and piston driven air motor, to permit driving the vehicle
A piston driven air motor that has a pipeline for conveying compressed air to the motor from the compressed air fuel tank for driving the wheels on demand.
An insulated high pressure compressed air fuel tank has a pipeline for conveying the air to the motor, and the tank is secured to the vehicle chassis frame.
A wind turbine driven air compressor that stores high pressure air in a large insulated accumulator tank, which can convey compressed air to the vehicle compressed air insulated fuel tank for powering the vehicle piston driven air motor.

2. A Wind Powered Vehicle System claimed in claim 1 that has a land based wind driven source of high pressure compressed air in a large land based insulated storage tank that has sufficient capacity to fuel the insulated compressed air storage tank mounted on the chassis of the vehicle.

3. A wind powered compressed air vehicle system claimed in claim 1 that has a piston driven air motor which is coupled to a human operated throttle control valve which, when manipulated, causes a variable flow of high pressure compressed air to be introduced into the piston driven motor to produce a response for powering the vehicle.

4. A Wind Powered Vehicle System as claimed in claim 1 that has a land based wind driven source of high pressure air that is a wind driven turbine which drives a high pressure air compressor.

5. A non-polluting renewable fuel powered vehicle system that comprises:
A stationary refueling station comprised of a wind driven source of high pressure compressed air.
A vehicle comprised of drive wheels and a piston driven air motor for driving the drive wheels, and it has an insulated high pressure air storage tank mounted on the vehicle frame for providing high pressure air to the piston driven air motor that, on demand, causes movement of said vehicle relative to said refueling station.
A compressed air storage tank mounted to said vehicle that is selectively connectable to the refueling station for conveying compressed air to the storage fuel tank.

6. The vehicular system of claim 5 wherein said wind driven refueling station comprises a wind driven turbine for driving a high pressure air compressor.

7. The vehicular system of claim 5 wherein the air motor is a piston driven air motor.

8. The vehicular system of claim 5 wherein said refueling station additionally comprises a large reservoir of high pressure air.
